(19) United States
(12) Patent Application Publication
(10) Pub. No.: US 2016/0262060 A1
(43) Pub. Date: Sep. 8, 2016

(54) APPARATUS AND METHOD FOR ESTIMATING HANDOVER UNAVAILABLE AREAS

(71) Applicant: FUJITSU LIMITED, Kawasaki-shi (JP)

(72) Inventors: Kenichi NUNOKAWA, Yokohama (JP); Xingtong Sun, Kawasaki (JP)

(73) Assignee: FUJITSU LIMITED, Kawasaki-shi (JP)

(21) Appl. No.: 15/042,766

(22) Filed: Feb. 12, 2016

(30) Foreign Application Priority Data
Mar. 6, 2015 (JP) 2015-045315

(51) Int. Cl. H04W 36/00

(52) U.S. Cl. CPC H04W 36/0005

(57) ABSTRACT

An apparatus collects, from mobile stations, first information indicating communication qualities of communications between the mobile stations and base stations, in association with position information indicating a position of each of the mobile stations, and determines, based on the first information for each of zones corresponding to the position information, whether a handover communication of a first mobile station to a first zone is unavailable. Upon determining that the handover communication of the first mobile station to the first zone is unavailable, the apparatus specifies the first zone as an unavailable area. When availability of the handover communication to a second zone, which is adjacent to the first zone of the unavailable area, is not defined yet and the second zone is adjacent to a plurality of the first zones determined as the unavailable area, the apparatus estimates the second zone as the unavailable area.

### CROSS-REFERENCE TO RELATED APPLICATION

This application is based upon and claims the benefit of priority of the prior Japanese Patent Application No. 2015-045315, filed on Mar. 6, 2015, the entire contents of which are incorporated herein by reference.

### FIELD

The embodiment discussed herein is related to apparatus and method for estimating handover unavailable areas.

### BACKGROUND

A mobile station has a handover (HO) function of enabling, for example, when moving from a current cell to a move destination cell during communication, continuation of the communication by transferring the communication from the current cell to the move destination cell. However, if there is only a cell with low reception power as a move destination, the HO function may not be used, so that communication is cut off in the move destination. Therefore, telecommunication carriers design base station layouts such that a plurality of cells overlaps.

However, there may be a case where, even when base stations are arranged such that a plurality of cells overlaps, for example, communication quality is degraded due to change in environment, such as construction of a new high-rise building, and an area in which the HO function may not be used occurs.

Therefore, conventionally, it is difficult to check whether or not there exists a HO destination cell in each area unless a HO failure is actually detected, and therefore, after checking the number of HO failures in each cell, power in peripheral cells is increased and base stations are additionally constructed.

Japanese Laid-open Patent Publication No. 05-336564, Japanese Laid-open Patent Publication No. 2002-152104, and Japanese Laid-open Patent Publication No. 2011-061805 discuss related art.

### SUMMARY

According to an aspect of the invention, an apparatus collects, from mobile stations, first information indicating communication qualities of communications between the mobile stations and base stations, in association with position information indicating a position of each of the mobile stations, and determines, based on the first information for each of zones corresponding to the position information, whether a handover communication of a first mobile station to a first zone is unavailable. Upon determining that the handover communication of the first mobile station to the first zone is unavailable, the apparatus specifies the first zone as an unavailable area. When the availability of the handover communication to a second zone, which is adjacent to the first zone of the unavailable area, is not defined yet and the second zone is adjacent to a plurality of the first zones determined as the unavailable area, the apparatus estimates the second zone as the unavailable area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a HO monitoring system, according to an embodiment;

FIG. 2 is a block diagram illustrating an example of a hardware configuration in a mobile station, according to an embodiment;

FIG. 3 is a block diagram illustrating an example of a functional configuration of a CPU in the mobile station, according to an embodiment;

FIG. 4 is an explanatory table illustrating an example of quality information, according to an embodiment;

FIG. 5 is a block diagram illustrating an example of a hardware configuration in a base station, according to an embodiment;

FIG. 6 is a block diagram illustrating an example of a hardware configuration in a monitoring device, according to an embodiment;

FIG. 7 is an explanatory diagram illustrating an example of a functional configuration of a CPU and a storage unit in a monitoring device, according to an embodiment;

FIG. 8 is an explanatory diagram illustrating an example of meshes obtained by dividing a partial region into zones, according to an embodiment;

FIG. 9 is an explanatory table illustrating an example of a monitoring table, according to an embodiment;

FIGS. 10A, 10B, 10C, 10D, 10E, and 10F are explanatory tables illustrating an example of a processing operation related to a first analysis unit, according to an embodiment;

FIGS. 11A, 11B, 11C, 11D, 11E, 11F, and 11G are explanatory tables illustrating an example of a processing operation related to a second analysis unit, according to an embodiment;

FIG. 12 is an explanatory table illustrating an example of a monitoring table, according to an embodiment;

FIG. 13 is an explanatory table illustrating an example of an area table, according to an embodiment;

FIGS. 14A, 14B, 14C, 14D, 14E, and 14F are explanatory tables illustrating an example of a series of processing operations related to area defining processing of defining an area in an area table, according to an embodiment;

FIG. 15 is an explanatory table illustrating an example of a series of processing operations related to data clearing processing of clearing data in a monitoring table, according to an embodiment;

FIG. 16A is an explanatory table illustrating an example of a series of processing operations related to priority degree update processing performed at a timing under a condition illustrated in FIG. 14A, according to an embodiment;

FIG. 16B is an explanatory table illustrating an example of a series of processing operations related to priority degree update processing performed at a timing under a condition illustrated in FIG. 14F, according to an embodiment;

FIG. 17 is an operational flowchart illustrating an example of a processing operation of a monitoring device related to first analysis processing, according to an embodiment;

FIG. 18 is an operational flowchart illustrating an example of a processing operation of the monitoring device related to second analysis processing, according to an embodiment;

FIG. 19 is an operational flowchart illustrating an example of a processing operation of a monitoring device related to area defining processing, according to an embodiment;

FIG. 20 is an operational flowchart illustrating an example of a processing operation of a monitoring device related to data clearing processing, according to an embodiment;

FIG. 21 is an operational flowchart illustrating an example of a processing operation of a monitoring device related to priority degree update processing, according to an embodiment; and

FIG. 22 is an explanatory diagram illustrating an example of an information processing device that executes a monitoring program, according to an embodiment.

### DESCRIPTION OF EMBODIMENT

Although an area in which a HO failure has occurred may be recognized after actually checking the number of HO failures in each cell, an area in which a HO failure is likely to occur may not be detected in advance.

In one aspect, it is desirable to enable estimation of an area in which a HO failure is likely to occur.

An embodiment related to a monitoring device, a monitoring method, and a monitoring program disclosed herein will be described in detail with reference to the accompanying drawings. Note that the embodiment is not intended to limit a technology disclosed herein. Also, features of the embodiment described below may be combined, as appropriate, within a scope in which contradiction does not occur.

### Embodiment

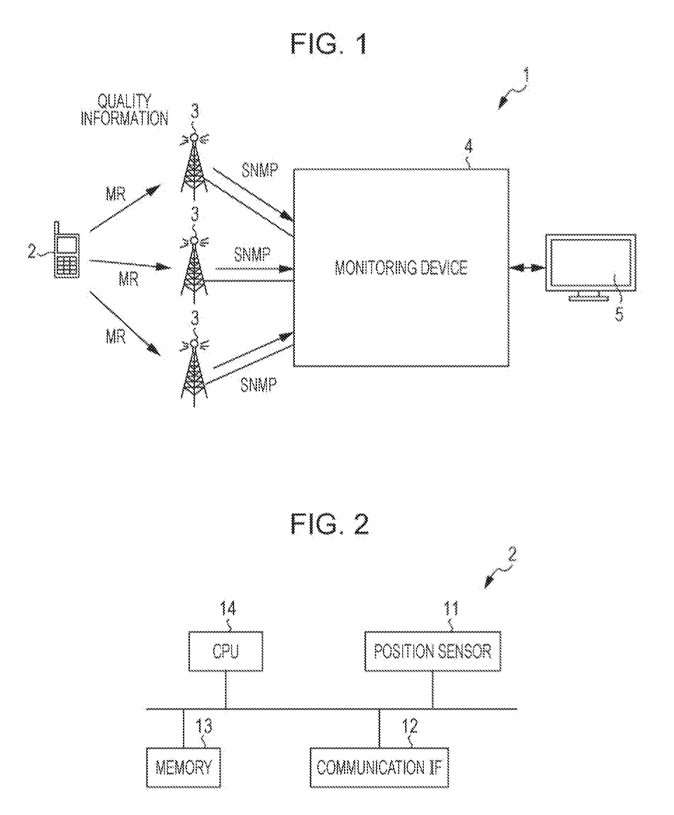

FIG. 1 is a block diagram illustrating an example of a HO monitoring system 1 according to this embodiment. The HO monitoring system 1 illustrated in FIG. 1 includes a plurality of mobile stations 2, a plurality of base stations 3, a monitoring device 4, and a monitoring terminal 5. Each of the mobile stations 2 is, for example, a wireless terminal, such as a mobile phone and a smart phone, which wirelessly communicates with the base stations 3 in cells of the base stations 3. Each of the base stations 3 is a device that wirelessly communicates with the mobile stations 2 in cells of the each base station 3. The monitoring device 4 is, for example, a server that collects quality information of each of the mobile stations 2, which will be described later, via the corresponding one of the base stations 3 and specifies, based on a result of analysis of the quality information, for example, a HO error area, a HO area, an undefined area, and the like of each region. Note that the HO area is an area having a communication environment in which HO is available, the HO error area is an area having a communication environment in which HO is unavailable, an undefined area is an area having a communication environment in which the HO area or the HO error area is undefined. The monitoring terminal 5 is, for example, a terminal of a maintenance party, which is coupled to the monitoring device 4, and acquires a result of monitoring performed by the monitoring device 4.

FIG. 2 is a block diagram illustrating an example of a hardware configuration in the mobile station 2. The mobile station 2 illustrated in FIG. 2 includes a position sensor 11, a communication interface (IF) 12, a memory 13, and a central processing unit (CPU) 14. The position sensor 11 is, for example, a measuring device that measures position information indicating a current position (latitude and longitude) of the mobile station 2 by using a global positioning system (GPS) or the like. The communication IF 12 is, for example, an interface that conducts wireless communication with the base stations 3. The memory 13 corresponds to a random access memory (RAM), such as a synchronous dynamic random access memory (SDRAM), a read only memory (ROM), a flash memory, or the like, and is an area in which various programs, pieces of information used for various types of processing, and the like are stored. The CPU 14 is a processor that controls the entire mobile station 2.

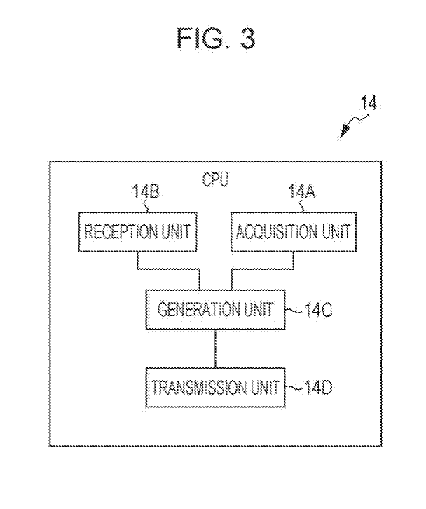

FIG. 3 is a block diagram illustrating an example of a functional configuration of the CPU 14 in the mobile station 2. The CPU 14 reads out a collection program stored in the memory 13 and forms various processes as functions, based on the readout collection program. The CPU 14 includes, as a functional configuration, an acquisition unit 14A, a reception unit 14B, a generation unit 14C, and a transmission unit 14D.

The acquisition unit 14A acquires position information indicating the current position of the mobile station 2, which is a result of measurement performed by the position sensor 11. The reception unit 14B acquires reception quality related to wireless communication with each base station 3 around the current position, for example, using a measurement report (MR) of RRC (TS25.331). Note that the reception quality includes a cell ID that identifies a cell of the base station 3 with which the mobile station 2 wirelessly communicates and a radio field intensity that indicates reception power (RSRP) of the mobile station 2 from the base station 3 with which the mobile station 2 wirelessly communicates. The generation unit 14C generates quality information, based on the position information of the mobile station 2, which has been acquired by the acquisition unit 14A, and the reception quality, which has been acquired by the reception unit 14B. The transmission unit 14D transmits the quality information, which has been generated by the generation unit 14C, to the base station 3. Note that, when quality information is generated, the transmission unit 14D transmits the quality information to the base station 3 during communication or at regular intervals.

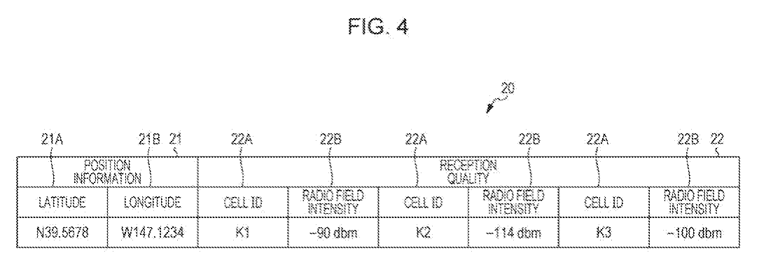

FIG. 4 is an explanatory table illustrating an example of quality information 20. The quality information 20 illustrated in FIG. 4 is communication quality including position information 21 that indicates a measured position of the mobile station 2 and reception quality 22 of the mobile station 2. The position information 21 includes position coordinates, such as a latitude 21A and a longitude 21B, which indicate the measured position of the mobile station 2. The reception quality 22 manages a cell ID 22A that identifies a cell of each base station 3 with which the mobile station 2 has wirelessly communicated at the measured position and a radio field intensity 22B. When there is a plurality of base stations 3 with which the mobile station 2 is able to communicate, the reception quality 22 includes the cell ID 22A and the radio field intensity 22B for each of the base stations 3. The reception quality 22 in the quality information 20 illustrated in FIG. 4 includes, for example, the radio field intensity of a cell ID “K1”, the radio field intensity of a cell ID “K2”, and the radio field intensity of a cell ID “K3”.

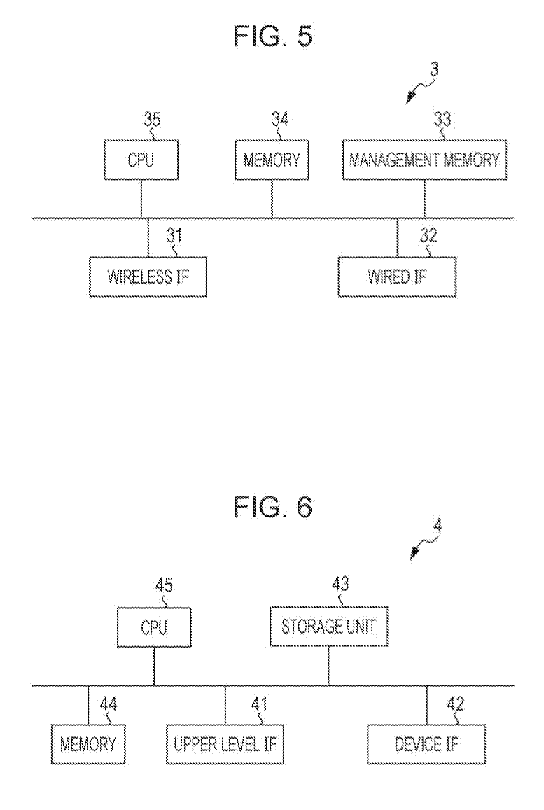

FIG. 5 is a block diagram illustrating an example of a hardware configuration in the base station 3. The base station 3 illustrated in FIG. 5 includes a wireless IF 31, a wired IF 32, a management memory 33, a memory 34, and a CPU 35. The wireless IF 31 is a communication interface that conducts wireless communication with the mobile station 2 in a cell of the base station 3. The wired IF 32 is a communication interface that conducts wired communication with, for example, another base station 3 and the monitoring device 4. The management memory 33 is an area in which a mobile station ID that identifies the mobile station 2 whose position has been registered in a cell of the base station 3, position information, and the like are managed. The memory 34 corresponds to, for example, a random access memory (RAM), such as a synchronous dynamic random access memory (SDRAM), a read only memory (ROM), and a flash memory, and is an area in which various programs, pieces of information used for various types of processing, and the like are stored. The CPU 35 is a processor that controls the entire base station 3.

The wired IF 32 transfers quality information received from each mobile station 2 to the monitoring device 4, for example, using a Simple Network Management Protocol (SNMP) and a Technical Report 069:CPE WAN Management Protocol (TR-069).

FIG. 6 is a block diagram illustrating an example of a hardware configuration in the monitoring device 4. The monitoring device 4 illustrated in FIG. 6 includes an upper level IF 41, a device IF 42, a storage unit 43, a memory 44, and a CPU 45. The upper level IF 41 is an interface that conducts communication with the monitoring terminal 5. The device IF 42 is an interface that conducts communication with another base station 3. The storage unit 43 is an area in which various types of information are stored. The memory 44 corresponds to, for example, a random access memory (RAM), such as a synchronous dynamic random access memory (SDRSM), a read only memory (ROM), a flash memory, or the like, and is an area in which various programs, pieces of information used for various types of processing, and the like are stored. The CPU 45 is a processor that controls the entire monitoring device 4.

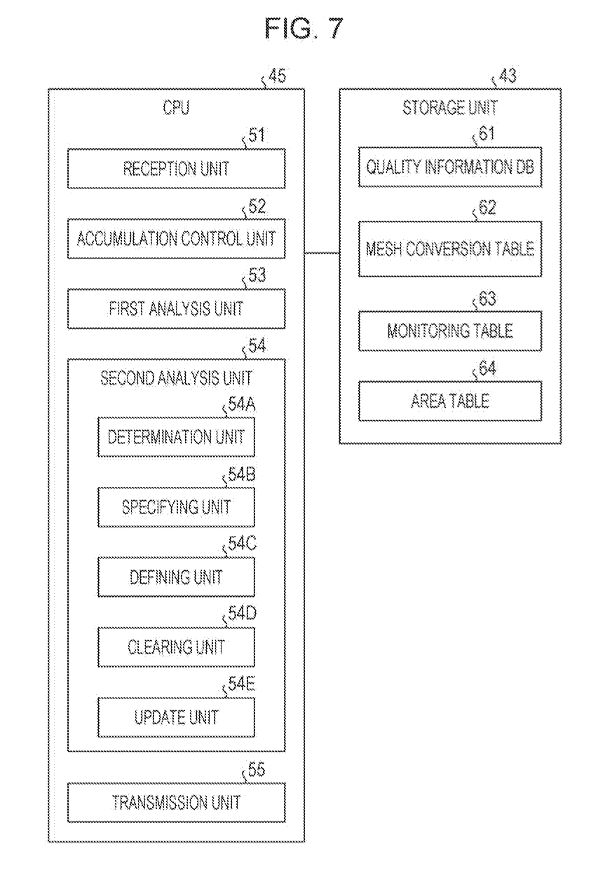

FIG. 7 is an explanatory diagram illustrating an example of a functional configuration of the CPU 45 and the storage unit 43 in the monitoring device 4. The CPU 45 reads out a monitoring program stored in the memory 44, and forms various processes as functions, based on the readout monitoring program. The CPU 45 includes, as a functional configuration, a reception unit 51, an accumulation control unit 52, a first analysis unit 53, a second analysis unit 54, and a transmission unit 55. The storage unit 43 includes quality information DB 61, a mesh conversion table 62, a monitoring table 63, and an area table 64.

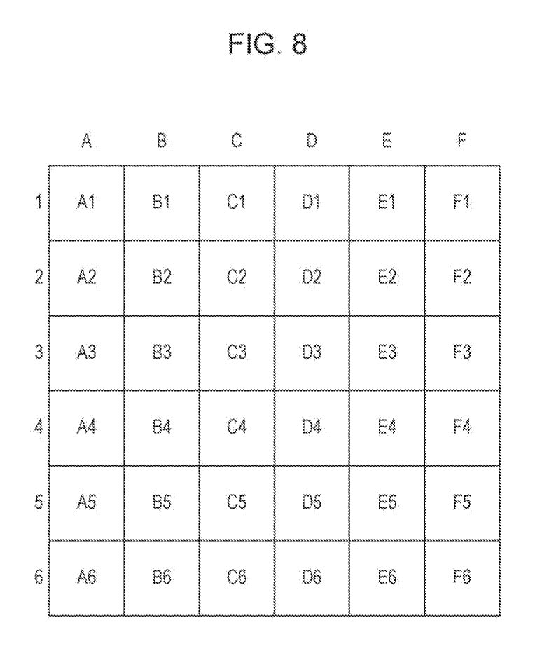

The reception unit 51 receives quality information collected by each mobile station 2 via the device IF 42. The accumulation control unit 52 stores the quality information of each mobile station 2, which has been received by the reception unit 51, in the quality information DB 61. The first analysis unit 53 specifies a mesh number, based on the latitude 21A and the longitude 21B in the position information 21 in the quality information 20, with reference to the mesh conversion table 62. Note that the mesh number is a number that identifies one (mesh) of zones into which the entire domestic region is divided in compliance with the Administrative Management Agency Notice No. 143. The mesh conversion table 62 manages the position coordinates (latitude and longitude) of map information in association with each mesh number. FIG. 8 is an explanatory diagram illustrating an example of meshes obtained by dividing a partial region into zones. Note that, for the sake of convenience, a partial region is divided into 36 areas with 36 mesh numbers in total, but the embodiment is not limited thereto. In the map illustrated in FIG. 8, as x coordinates, A to F are provided and, as y coordinates, 1 to 6 are provided, and the map is divided into 36 meshes in total, that is, meshes A1 to A6, B1 to B6, C1 to C6, D1 to D6, E1 to E6, and F1 to F6. The first analysis unit 53 specifies position information 21 (the latitude 21A and the longitude 21B) in the quality information 20 as the mesh number with reference to the mesh conversion table 62. The first analysis unit 53 analyzes the reception quality 22 for each mesh number and, as a result of the analysis, resisters, for example, the number of reports, the number of good receptions, the number of times of progress observation, and the degree of report priority in the monitoring table 63.

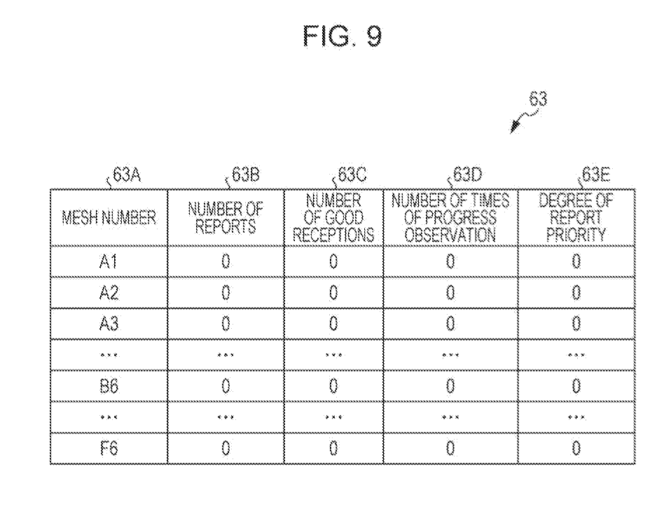

FIG. 9 is an explanatory table illustrating an example of the monitoring table 63. The monitoring table 63 illustrated in FIG. 9 manages the number of reports 63B, the number of good receptions 63C, the number of times of progress observation 63D, and the degree of report priority 63E in association with each mesh number 63A. The number of reports 63B is the number of times a report of reception of the quality information has been made in the area corresponding to the mesh number. The number of good receptions 63C is the number of times an area corresponding to the mesh number has been determined to be a HO area when the number of cells having a predetermined radio field intensity or more becomes a predetermined number of cells or more in the area corresponding to the mesh number. The number of times of progress observation 63D is a counter value which is incremented by one, for example, when the area is determined to be an undefined area in the area corresponding to the mesh number, and used for observing a progress of change in the state of the area corresponding to the mesh number. The degree of report priority 63E is the degree of priority with which a HO error range including a HO error area is reported to the monitoring terminal 5 in the area corresponding to the mesh number.

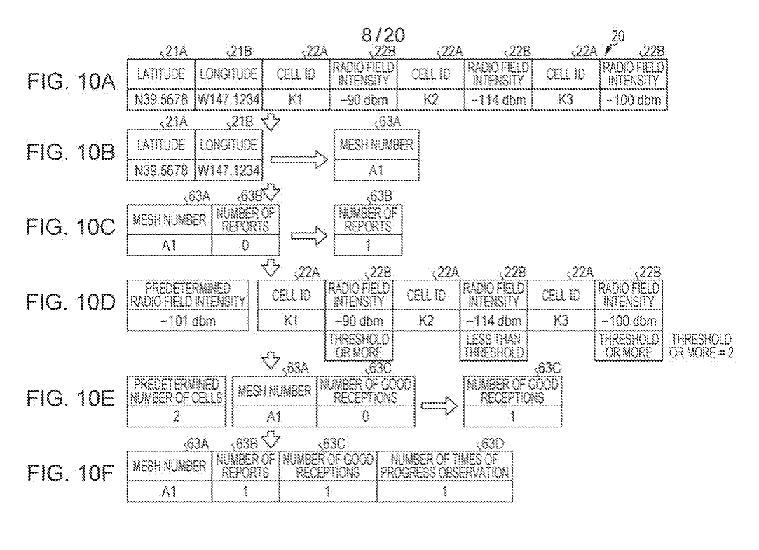

FIGS. 10A, 10B, 10C, 10D, 10E, and 10F are explanatory tables illustrating an example of a processing operation related to the first analysis unit 53. When quality information from the mobile station 2 is received via the reception unit 51, the accumulation control unit 52 stores the received quality information to the quality information DB 61. Then, the first analysis unit 53 analyzes the received quality information in the quality information DB 61 for each mesh number.

As illustrated in FIG. 10A, the first analysis unit 53 receives the quality information 20 from the mobile station 2. The quality information 20 includes the radio field intensities 22B of the cell IDs 22A (K1, K2, and K3) that identify cells of the three base stations 3 at the latitude 21A and the longitude 21B. The first analysis unit 53 acquires a mesh number “A1”, based on the latitude 21A and the longitude 21B in the quality information 20 illustrated in FIG. 10B, with reference to the mesh conversion table 62.

As illustrated in FIG. 10C, the first analysis unit 53 receives the quality information of the mesh number “A1”, and therefore, increments the number of reports 63B of the mesh number “A1” in the monitoring table 63 by one and thereby updates the number of reports 63B of the mesh number “A1” in the monitoring table 63.

As illustrated in FIG. 10D, the first analysis unit 53 determines whether or not the radio field intensity in the reception quality of each of the base stations 3 in the quality information related to the mesh number “A1” is a predetermined radio field intensity or more. Note that the predetermined radio field intensity is a threshold, that is, for example, “−101 dbm”, which determines whether or not a cell has a radio field intensity with which HO is made available. When the radio field intensity of the cell ID “K1” is “−90 dbm”, the radio field intensity is the predetermined radio field intensity or more, and therefore, the first analysis unit 53 increments the number of cells with good reception by one. Furthermore, when the radio field intensity of the cell ID “K2” is “−114 dbm”, the radio field intensity is less than the predetermined radio field intensity, and therefore, the first analysis unit 53 does not count the number of cells with good reception. Furthermore, when the radio field intensity of the cell ID “K3” is “−100 dbm”, the radio field intensity is the predetermined radio field intensity or more, and therefore, the first analysis unit 53 increments the number of cells with good reception by one. That is, the first analysis unit 53 tallies the number of cells with good reception of the mesh number “A1” to obtain “2”.

The first analysis unit 53 determines whether or not the number of cells with good reception of the mesh number “A1” is the predetermined number of cells or more. In this case, it is assumed that the predetermined number of cells is the number of cells, that is, for example, 2, with which HO is made available in the area of the mesh number “A1”. When the number of cells with good reception of the mesh number “A1” is “2”, the number of cells with good reception is the predetermined number of cells or more, and therefore, as illustrated in FIG. 10E, the first analysis unit 53 increments the number of good receptions 63C of the mesh number “A1” in the monitoring table 63 by one and thereby updates the number of good receptions 63C of the mesh number “A1” in the monitoring table 63.

As a result, as illustrated in FIG. 10F, the first analysis unit 53 sets the number of reports 63B, the number of good receptions 63C, and the number of times of progress observation 63D of the mesh number “A1” in the monitoring table 63 at “1”, “1”, and “1”, respectively. In the case, it is assumed that an initial setting of the number of times of progress observation 63D is “1”. The first analysis unit 53 analyzes quality information for each mesh number received in the quality information DB 61 and updates the number of reports 63B, the number of good receptions 63C, and the number of times of progress observation 63D in the monitoring table 63 with the analysis result of the first analysis unit 53.

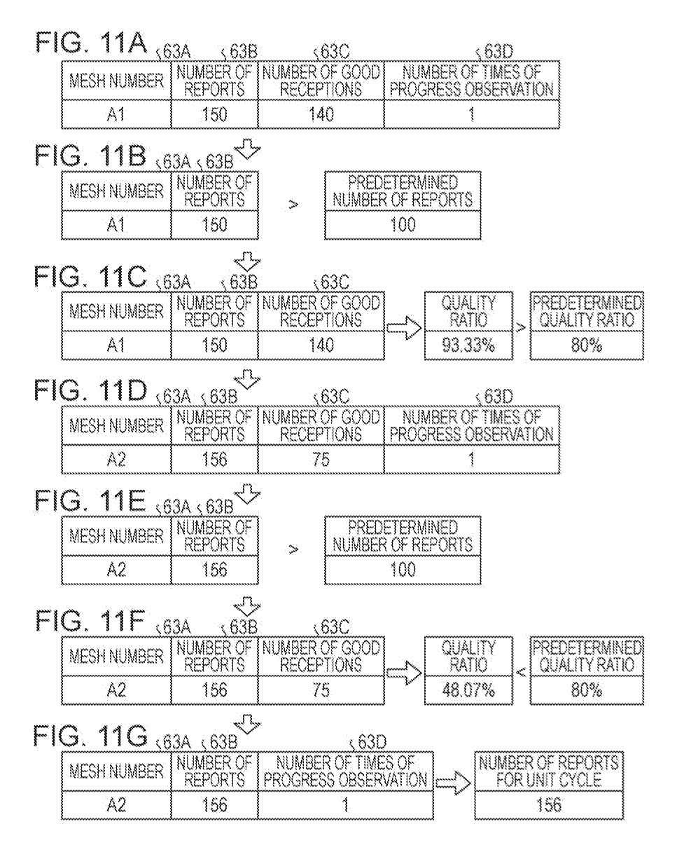

The second analysis unit 54 includes a determination unit 54A, a specifying unit 54B, a defining unit 54C, a clearing unit 54D, and an update unit 54E. FIGS. 11A, 11B, 11C, 11D, 11E, 11F, and 11G are explanatory tables illustrating an example of a processing operation related to the second analysis unit 54. The determination unit 54A in the second analysis unit 54 determines, based on the number of reports 63B, the number of good receptions 63C, and the number of times of progress observation 63D for each mesh number 63A in the monitoring table 63, an area condition of the mesh number 63A for each predetermined cycle.

As illustrated in FIG. 11A, the determination unit 54A refers to the number of reports, “150”, the number of good receptions, “140”, and the number of times of progress observation, “1”, which correspond to the mesh number “A1” in the monitoring table 63.

As illustrated in FIG. 11B, the determination unit 54A determines whether or not the number of reports 63B of the mesh number “A1” is a predetermined number of reports or more. Note that the predetermined number of reports is the number of times, for example, 100 times, of determining whether or not the number of reports has reached the number of samples which is sufficient for area determination of the corresponding mesh number 63A. When the number of reports 63B of the mesh number “A1” is “150”, the number of reports 63B of the mesh number “A1” is the predetermined number of reports or more, and therefore, the determination unit 54A determines that the number of reports 63B of the mesh number “A1” has reached the number of samples which is sufficient for area determination.

If the number of reports 63B of the mesh number “A1” is the predetermined number or more, as illustrated in FIG. 11C, the determination unit 54A extracts the number of reports, “150”, and the number of good receptions, “140”, which correspond to the mesh number “A1”, from the monitoring table 63. The determination unit 54A calculates the quality ratio, based on the number of good receptions/the number of reports ×100%. That is, for example, the determination unit 54A calculates the quality ratio, 93.33%, of the mesh number “A1”, based on 140/150×100%. Furthermore, the determination unit 54A determines whether or not the calculated quality ratio is a predetermined quality ratio or more. Note that the predetermined quality ratio is a quality ratio used for determining whether or not the quality ratio of the corresponding mesh number 63A is a HO area or a HO error area, and is, for example, 80%. When the quality ratio of the mesh number “A1” is 93.33%, the quality ratio of the mesh number “A1” is the predetermined quality ratio or more, and therefore, the specifying unit 54B in the second analysis unit 54 determines the area of the mesh number “A1” as a HO area.

As illustrated in FIG. 11D, the determination unit 54A designates a next undesignated mesh number “A2” and refers to the number of reports, “156”, the number of good receptions, “75”, and the number of times of progress observation, “1”, which correspond to the mesh number “A2”.

As illustrated in FIG. 11E, the determination unit 54A determines whether or not the number of reports 63B of the mesh number “A2” is the predetermined number of reports or more. When the number of reports 63B of the mesh number “A2” is “156”, the number of reports 63B of the mesh number “A2” is the predetermined number of reports (100 times) or more, and therefore, the determination unit 54A determines that the number of reports 63B of the mesh number “A2” has reached the number of samples which is sufficient for area determination.

When the number of reports 63B of the mesh number “A2” is the predetermined number of reports or more, as illustrated in FIG. 11F, the determination unit 54A extracts the number of reports, “156”, and the number of good receptions, “75”, which correspond to the mesh number “A2”, from the monitoring table 63. The determination unit 54A calculates the quality ratio, 48.07%, of the mesh number “A2”, based on 75/156×100%. Furthermore, the quality ratio, 48.07%, of the mesh number “A2” is not the predetermined quality ratio of 80% or more, and therefore, the specifying unit 54B determines the area of the mesh number “A2” as a HO error area. Furthermore, as illustrated in FIG. 11G, the number of reports and the number of times of progress observation of the mesh number “A2” are “156” and “1”, respectively, and therefore, the determination unit 54A determines that the number of reports for a unit cycle is “156”.

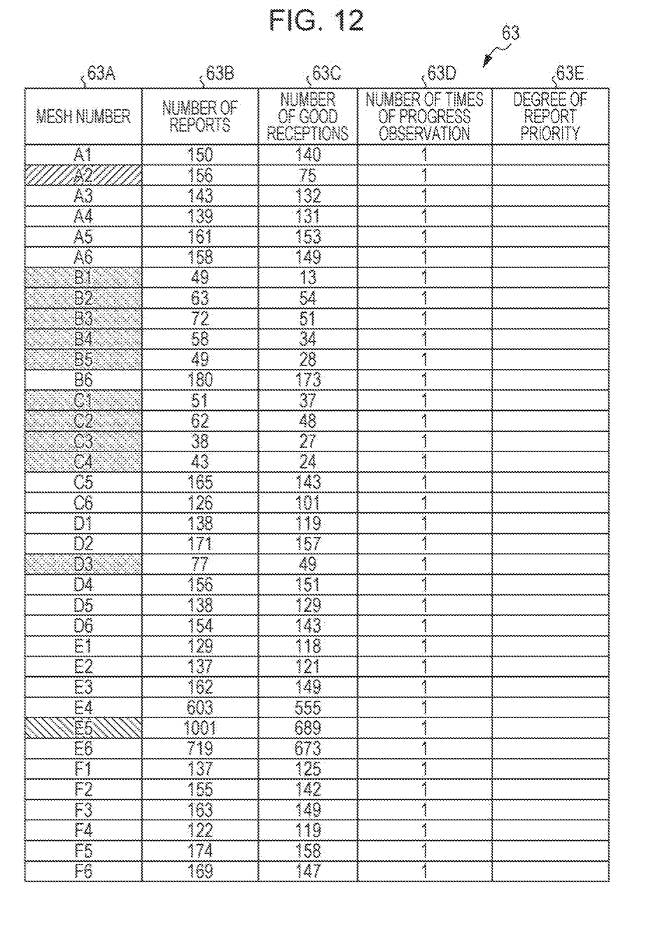

That is, the determination unit 54A sequentially determines whether or not the number of reports 63B is the predetermined number of reports or more for each mesh number 63A, and when the number of reports 63B is the predetermined number of reports or more, the determination unit 54A determines whether or not the quality ratio thereof is the predetermined quality ratio or more. When the quality ratio of the corresponding mesh number 63A is the predetermined quality ratio or more, the specifying unit 54B determines that the area of the corresponding mesh number 63A is a HO area. When the quality ratio of the corresponding mesh number 63A is less than the predetermined quality ratio, the specifying unit 54B determines that the area of the corresponding mesh number 63A is a HO error area. When the number of reports 63B of the corresponding mesh number 63A is not the predetermined number of reports or more, the specifying unit 54B determines the area of the corresponding mesh number 63A as an undefined area. The second analysis unit 54 repeats analysis for each mesh number, to obtain results of analysis of the monitoring table 63 as illustrated in FIG. 12. FIG. 12 is an explanatory table illustrating an example of the monitoring table 63. In the case, the monitoring device 4 achieved determination results indicating that areas of the mesh numbers “A1”, “A3” to “A6”, “B6”, “C5” to “D2”, “D4” to “E4”, and “E6” to “F6” are HO areas. Furthermore, the monitoring device 4 achieved determination results indicating that areas of the mesh numbers “A2” and “E5” are HO error areas. Furthermore, the monitoring device 4 achieved determination results indicating that areas of the mesh numbers “B1” to “B5”, “C1” to “C4”, and “D3” are undefined areas.

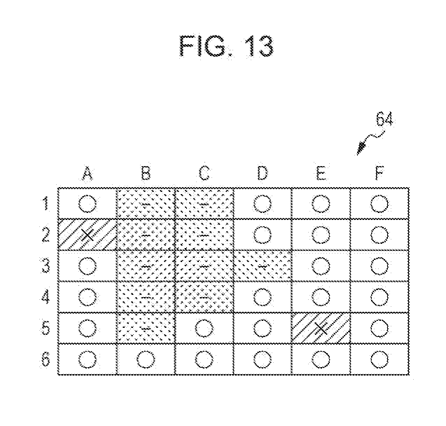

FIG. 13 is an explanatory table illustrating an example of the area table 64. In the area table 64 illustrated in FIG. 13, a HO area, a HO error area, and an undefined area are registered as “ο”, “χ”, and “-”, respectively, for each of areas of the mesh numbers. Note that the area table 64 illustrated in FIG. 13 reflects the results of analysis of the monitoring table 63 illustrated in FIG. 12.

In the area table 64, each of the areas of the mesh numbers “A1”, “A3” to “A6”, “B6”, “C5” to “D2”, “D4” to “E4”, and “E6” to “F6” is registered as “ο” representing a HO area. In the area table 64, each of the areas of the mesh numbers “A2” and “E5” is registered as “χ” representing a HO error area. In the area table 64, each of the areas of the mesh numbers “B1” to “B5”, “C1” to “C4”, and “D3” is registered as “-” representing an undefined area.

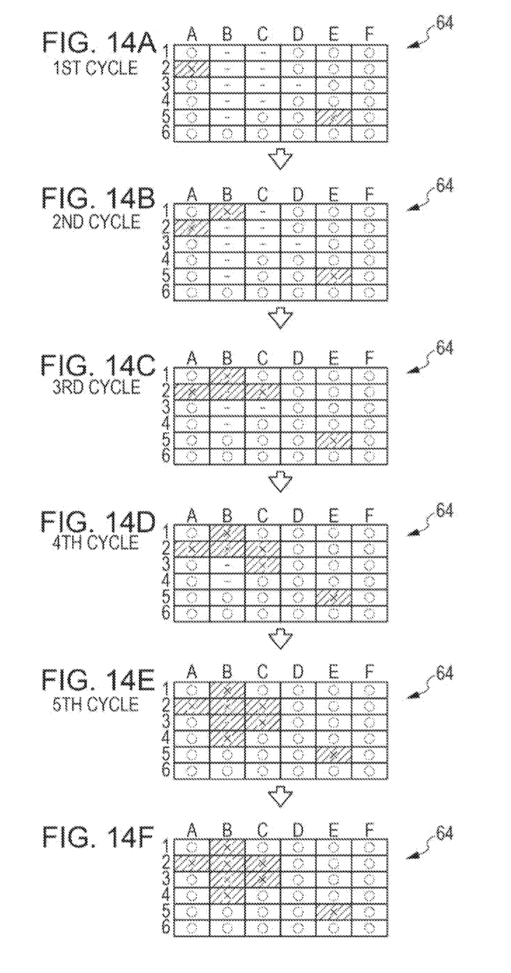

FIGS. 14A, 14B, 14C, 14D, 14E, and 14F are explanatory tables illustrating an example of a series of processing operations related to area defining processing of defining an area in the area table 64. It is assumed that the defining unit 54C in the second analysis unit 54 has determined that, in a first cycle illustrated in FIG. 14A, the areas of the mesh numbers “A1”, “A3” to “A6”, “B6”, “C5” to “D2”, “D4” to “E4”, and “E6” to “F6” to be HO areas. In this case, the defining unit 54C registers each of the areas of the above-described mesh numbers in the area table 64 as “ο”. Furthermore, when the areas of the mesh numbers “A2” and “E5” have been determined to be HO error areas, the defining unit 54C registers each of the areas of the above-described mesh numbers in the area table 64 as “χ”. When the areas of the mesh numbers “B1” to “B5”, “C1” to “C4”, and “D3” have been determined to be undefined areas, the defining unit 54C registers each of the areas of the above-described mesh numbers in the area table 64 as “-”. In this case, the defining unit 54C defines two HO error ranges of the mesh number “A2” and the mesh number “E5” in total.

Furthermore, it is assumed that the defining unit 54C has determined that, in a second cycle illustrated in FIG. 14B, the area of the mesh number “B1” is a HO error area, and the area of the mesh number “C4” is a HO area. In this case, the defining unit 54C registers the area of the mesh number “B1” and the area of the mesh number “C4” in the area table 64 as “χ” and “ο”, respectively. In this case, the defining unit 54C defines three HO error ranges of the mesh numbers “A2”, “E5”, and “B2 in total.

Furthermore, it is assumed that the defining unit 54C has determined that, in a third cycle illustrated in FIG. 14C, the area of the mesh number “C2” is a HO error area and the area of the mesh number “C1” is a HO area. The defining unit 54C registers the area of the mesh number “C2” and the area of the mesh number “C1” in the area table 64 as “χ” and “ο”, respectively. In this case, with focus on the undefined area of the mesh number “B2”, which is an undefined area indicated by “-”, the area of the mesh number “B2” is adjacent to a plurality of areas indicated by “χ”, and therefore, the defining unit 54C estimates the undefined area of the mesh number “B2” as a HO error area “χ” and registers the undefined area of the mesh number “B2” as a HO error area “χ”. In this case, the defining unit 54C defines two HO error ranges in total, that is, a HO error range of the mesh numbers “A2”, “B1”, “B2”, and “C2” and a HO error range of the mesh number “E5”.

Furthermore, when it is determined that, in a fourth cycle illustrated in FIG. 14D, the area of the mesh number “C3” is a HO error area, the defining unit 54C registers the area of the mesh number “C3” in the area table 64 as “χ”. In this case, the defining unit 54C defines two HO error ranges in total, that is, a HO error range of the mesh numbers “A2”, “B1”, “B2”, “C2”, and “C3” and a HO error range of the mesh number “E5”.

Furthermore, when it is determined that, in a fifth cycle illustrated in FIG. 14E, the area of the mesh number “B4” is a HO error area, the defining unit 54C registers the area of the mesh number “B4” in the area table 64 as “χ”. In this case, the defining unit 54C focuses on the area of the mesh number “B3”, which is an undefined area of “-”. Then, as illustrated in FIG. 14F, the undefined area of the mesh number “B3” is adjacent to a plurality of areas indicated by “χ”, and therefore, the defining unit 54C registers the undefined area of the mesh number “B3” as a HO error area “χ”. As a result, the defining unit 54C defines two HO error ranges in total, that is, a HO error range of the mesh numbers “A2”, “B1”, “B2”, “B3”, “B4”, “C2”, and “C3” and a HO error range of the mesh number “E5”. Note that the defining unit is, for example, an estimation unit and a defining unit.

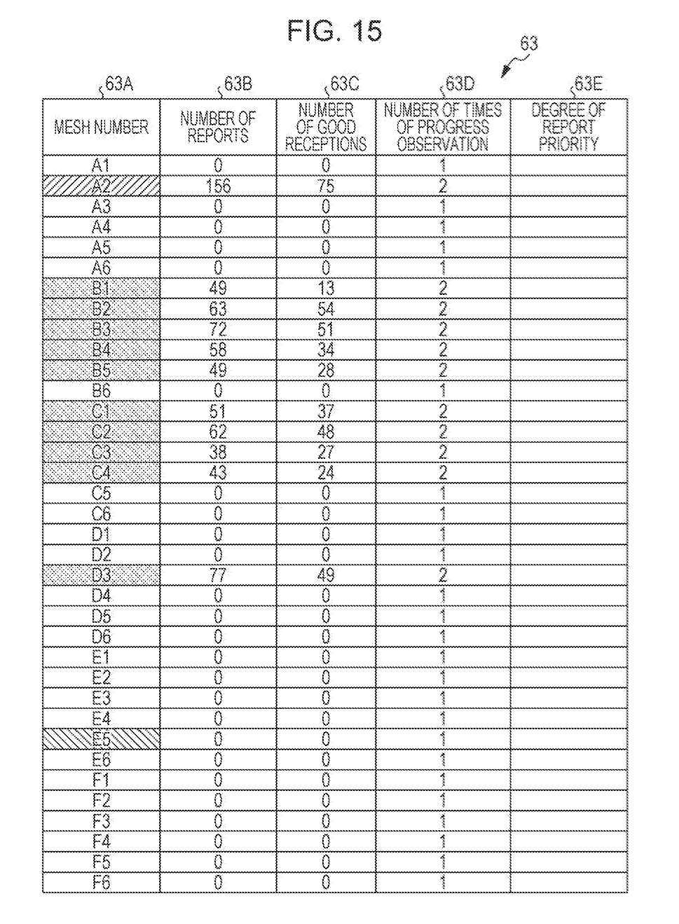

FIG. 15 is an explanatory table illustrating an example of a series of processing operations related to data clearing processing for clearing data in the monitoring table 63. Since each of the mesh numbers “Al”, “A3” to “A6”, “B6”, “C5”, “C6”, “D1”, “D2”, “D4” to “D6”, “El” to “E4”, “E6”, “F1” to “F6” is registered as “ο” in the area table 64, the clearing unit 54D in the second analysis unit 54 clears the number of reports 63B and the number of good receptions 63C of the corresponding mesh number 63A in the monitoring table 63. Then, the clearing unit 54D sets the number of times of progress observation 63D of the corresponding mesh number 63A at an initial value “1”. When the number of times of progress observation 63D of the corresponding mesh number 63A exceeds the effective number of times, the clearing unit 54D clears the number of reports 63B and the number of good receptions 63C of the mesh numbers 63A and sets the number of times of progress observation 63D to the initial value “1”. Also, when the number of times of progress observation 63D of each of the mesh numbers “B1” to “B5”, “C1” to “C4”, and “D3” in the monitoring table 63 exceeds the effective number of times, for example, 10 times, the clearing unit 54D sets the number of reports 63B and the number of good receptions 63C of the corresponding mesh number 63A at “0”. Furthermore, the clearing unit 54D sets the number of times of progress observation 63D of the corresponding mesh number 63A at “1”.

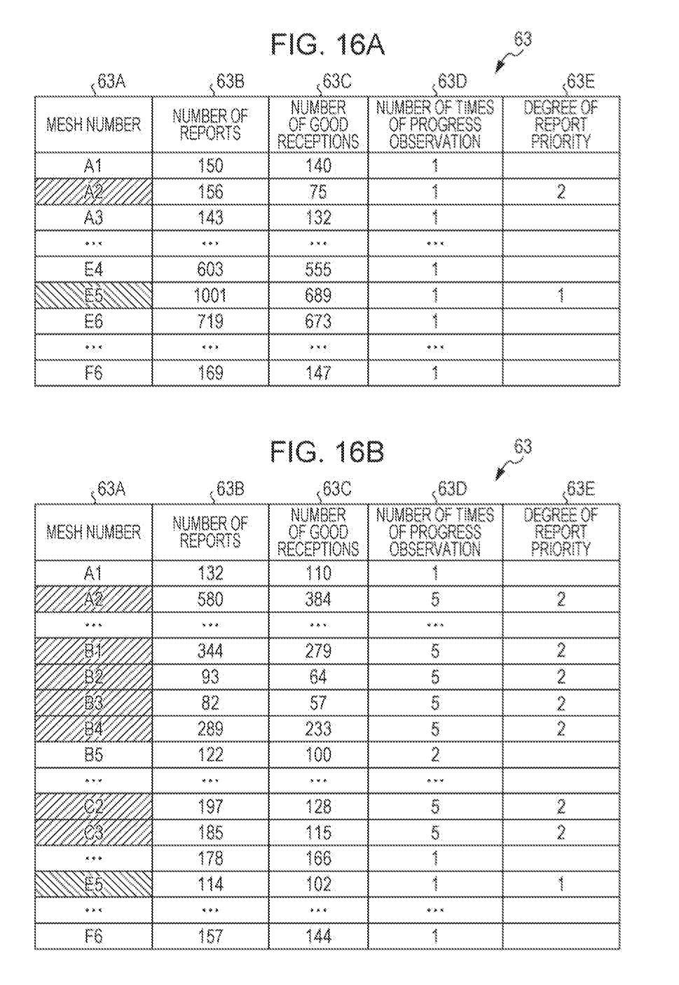

FIG. 16A is an explanatory table illustrating an example the monitoring table 63 related to priority degree update processing performed at a timing under a condition illustrated in FIG. 14A, and FIG. 16B is an explanatory table illustrating an example of the monitoring table 63 related to priority degree update processing performed at a timing under a condition illustrated in FIG. 14F.

Under the condition illustrated in FIG. 14A, two HO error ranges of the mesh number “A2” and the mesh number “E5” in total are defined. The update unit 54E acquires the numbers of reports 63B for the mesh number “A2” and the mesh number “E5”. Furthermore, the update unit 54E compares the numbers of reports 63B of the mesh number “A2” and the mesh number “E5” to each other. Since the number of reports 63B of the mesh number “A2” is “156” and the number of reports 63B of the mesh number “E5” is “1001”, the number of reports 63B of the mesh number “E5” is larger than that of the mesh number “A2”, and therefore, the update unit 54E causes the priority degree of the HO error range of the mesh number “E5” to be higher than that of the mesh number “A2”. For example, the update unit 54E sets the degree of report priority 63E of the HO error range of the mesh number “E5” at “1”, and the degree of report priority 63E of the HO error range of the mesh number “A2” at “2”. As a result, the update unit 54E registers the degree of report priority 63E of the mesh number “E5” and the degree of report priority 63E of the mesh number “A2” in the monitoring table 63 as “1” and “2”, respectively.

Under the condition illustrated in FIG. 14F, two HO error ranges in total, that is, a first HO error range of the mesh numbers “A2”, “B1”, “B2”, “B3”, “B4”, “C2”, and “C3” and a second HO error range of the mesh number “E5”, are defined. The update unit 54E adds up all of numbers of reports related to the mesh numbers in the first HO error range and divides a result of the addition by the number of meshes to calculate an average number of reports. Furthermore, the update unit 54E calculates the number of reports of the mesh number “E5” in the second HO error range. The update unit 54E compares the average number of reports in the first HO error range and the average number of reports of the mesh number in the second HO error range to each other. The number of reports in the second HO error range is larger than that in the first HO error range, and therefore, the update unit 54E sets the degree of report priority in the second HO error range to “1” and the degree of report priority in the first HO error range to “2”. As a result, the update unit 54E registers the degree of report priority of the mesh number “E5” in the second HO error range in the monitoring table 63 as “1” and the degree of report priority of all of the mesh numbers in the first HO error range as “2”.

Then, the transmission unit 55 transmits, based on the degree of report priority for each HO error range, a HO error corresponding to the relevant mesh number in each HO error range, to the monitoring terminal 5. As a result, a user of the monitoring terminal 5 may recognize a HO error of each mesh number which has been sequentially received based on the degree of report priority.

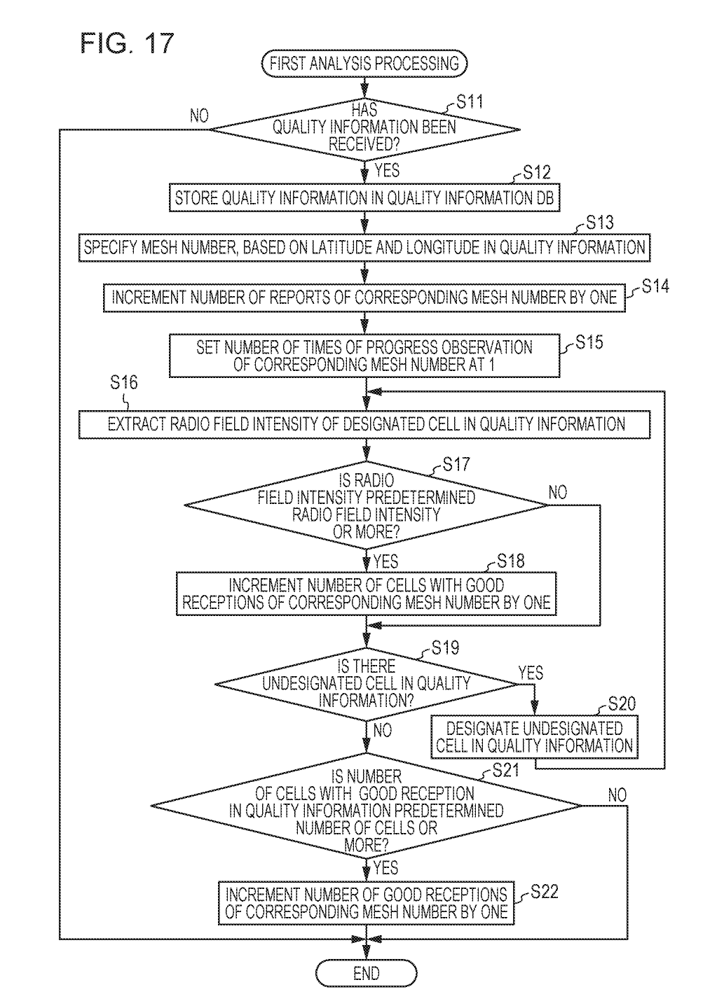

Next, an example of an operation of the HO monitoring system 1 according to the embodiment will be described. FIG. 17 is an operational flowchart illustrating an example of a processing operation of the monitoring device 4 related to the first analysis processing. The first analysis processing illustrated in FIG. 17 is a processing of referring to quality information collected from each of the mobile stations 2, specifying a mesh number, based on the latitude and the longitude in the quality information, tallying the number of reports and the number of good receptions for each mesh number, and registering the number of reports and the number of good receptions in the monitoring table 63. The reception unit 51 in the monitoring device 4 determines whether or not quality information collected in the mobile station 2 has been received from the corresponding base station 3 (Step S11). When the quality information has been received (YES in Step S11), the accumulation control unit 52 stores the quality information in the quality information DB 61 (Step S12).

The first analysis unit 53, with reference to the mesh conversion table 62, specifies the mesh number, based on the latitude 21A and the longitude 21B in the received quality information 20 (Step S13). The first analysis unit 53 increments the number of reports 63B which corresponds to the relevant mesh number 63A in the monitoring table 63 by one (Step S14), and sets the number of times of progress observation at “1” (Step S15). The first analysis unit 53 extracts the radio field intensity 22B of the designated cell from the received quality information 20 (Step S16) and determines whether or not the extracted radio field intensity 22B is a predetermined radio field intensity or more (Step S17).

When the extracted radio field intensity 22B is the predetermined radio field intensity or more (YES in Step S17), the first analysis unit 53 increments the number of cells with good reception of the corresponding mesh number by one (Step S18), and determines whether or not there is an undesignated cell in the received quality information (Step S19).

When there is a cell, which has not been designated yet, in the received quality information 20 (YES in Step S19), the first analysis unit 53 designate the cell (Step S20) and moves the process to Step S16 in order to extract the radio field intensity 22B of the designated cell.

When there is no cells left, which have not been designated yet, in the received quality information 20 (NO in Step S19), the first analysis unit 53 determines whether or not the number of cells with good reception of the corresponding mesh number of the received quality information 20 is a predetermined number of cells or more (Step S21). When the number of cells with good reception of the corresponding mesh number is the predetermined number of cells or more (YES in Step S21), the first analysis unit 53 increments the number of good receptions 63C of the corresponding mesh number 63A in the monitoring table 63 by one (Step S22), and terminates the processing operation illustrated in FIG. 17.

When the quality information 20 is not received in Step S11 (NO in Step S11), the reception unit 51 terminates the processing operation illustrated in FIG. 17. When the radio field intensity of the designated cell, which has been extracted, is not the predetermined radio field intensity or more (NO in Step S17), the first analysis unit 53 moves the process to Step S19 in order to determine whether or not there is a cell which has not been designated yet in the quality information. When the number of cells with good reception of the corresponding mesh number is not the predetermined number of cells or more (NO in Step S21), the first analysis unit 53 terminates the processing operation illustrated in FIG. 17.

In the first analysis processing, the position information 21 and the reception quality 22 in the quality information 20 collected from each of the mobile stations 2 are referred to. In the first analysis processing, when there are cells whose radio field intensity 22B is the predetermined radio field intensity or more and whose number is the predetermined number of cells or more for each mesh number, the number of reports 63B and the number of good receptions 63C are tallied for each mesh number 63A and are thus registered in the monitoring table 63. As a result, the monitoring device 4 may recognize the number of reports 63B and the number of good receptions 63C for each mesh number 63A with reference to the monitoring table 63.

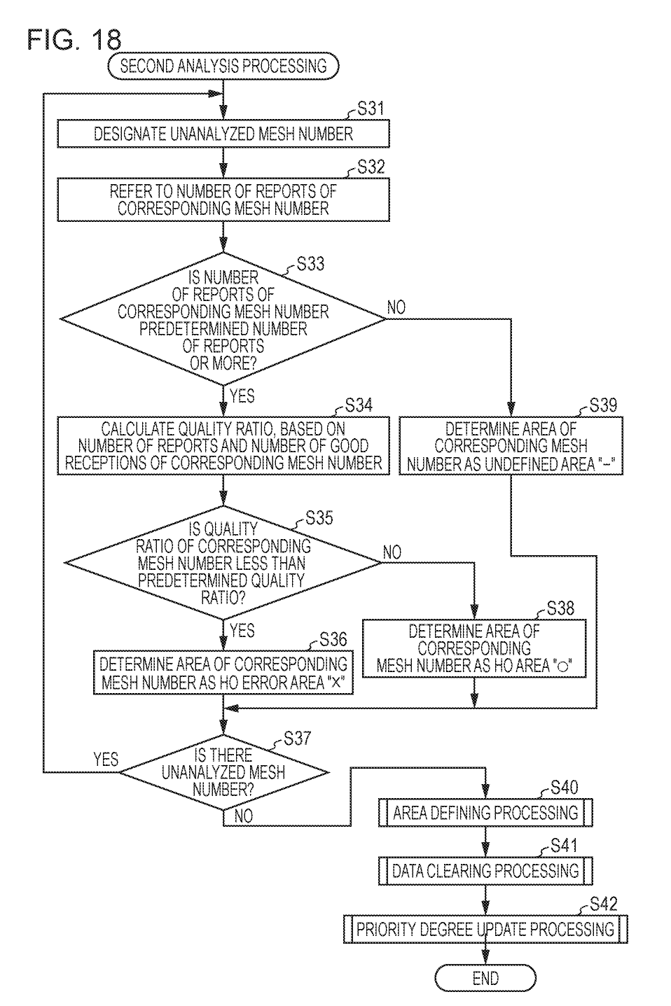

FIG. 18 is an operational flowchart illustrating an example of a processing operation of the monitoring device 4 related to the second analysis processing. The second analysis processing illustrated in FIG. 18 is processing of analyzing a condition of an area corresponding to the relevant mesh number, based on the number of reports 63B and the number of good receptions 63C for each mesh number 63A. The second analysis unit 54 executes the second analysis for each predetermined cycle. In FIG. 18, the determination unit 54A in the second analysis unit 54 in the monitoring device 4 designates a mesh number 63A, which has not been analyzed yet, in the monitoring table 63 (Step S31), and refers to the number of reports 63B of the mesh number 63A (Step S32).

The determination unit 54A determines whether or not the number of reports 63B of the corresponding mesh number 63A is the predetermined number of reports or more (Step S33). When the number of reports 63B of the corresponding mesh number 63A is the predetermined number of reports or more (YES in Step S33), the determination unit 54A calculates the quality ratio, based on the number of reports 63B and the number of good receptions 63C of the corresponding mesh number 63A (Step S34). Note that the determination unit 54A may calculate the quality ratio for each corresponding mesh number, for example, based on the following expression:

(the number of good receptions/the number of reports)×100%.

The determination unit 54A determines whether or not the quality ratio of the corresponding mesh number 63A is less than the predetermined quality ratio (Step S35). When the quality ratio of the corresponding mesh number 63A is less than the predetermined quality ratio (YES in Step S35), the specifying unit 54B determines the area of the corresponding mesh number as a HO error area. Then, the specifying unit 54B registers the area of the corresponding mesh number in the area table 64 as “χ” (Step S36) and determines whether or not there is an unanalyzed mesh number left (Step S37).

When the quality ratio of the corresponding mesh number 63A is not less than the predetermined quality ratio (NO in Step S35), the specifying unit 54B determines the area of the corresponding mesh number as a HO area. Then, the specifying unit 54B registers the area of the corresponding mesh number in the area table 64 as “ο” (Step S38), and moves the process to Step S37 in order to determine whether or not there is an unanalyzed mesh number.

Also, when the number of reports 63B of the corresponding mesh number 63A is not the predetermined number of reports or more (NO in Step S33), the specifying unit 54B determines the area of the corresponding mesh number as an undefined area. Furthermore, the specifying unit 54B registers the area of the corresponding mesh number in the area table 64 as “-” (Step S39) and moves the process to Step S37 in order to determine whether or not there is an unanalyzed mesh number left.

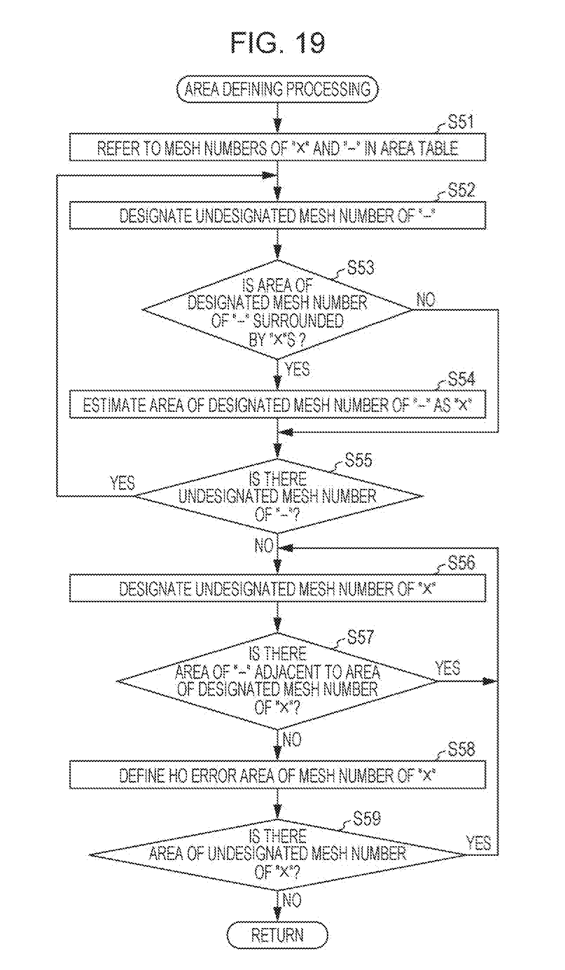

When there is an unanalyzed mesh number (YES in Step S37), the second analysis unit 54 moves the process to Step S31 in order to designate the unanalyzed mesh number. When there is not an unanalyzed mesh number (NO in Step S37), the second analysis unit 54 executes the area defining processing illustrated in FIG. 19, which will be described later (Step S40).

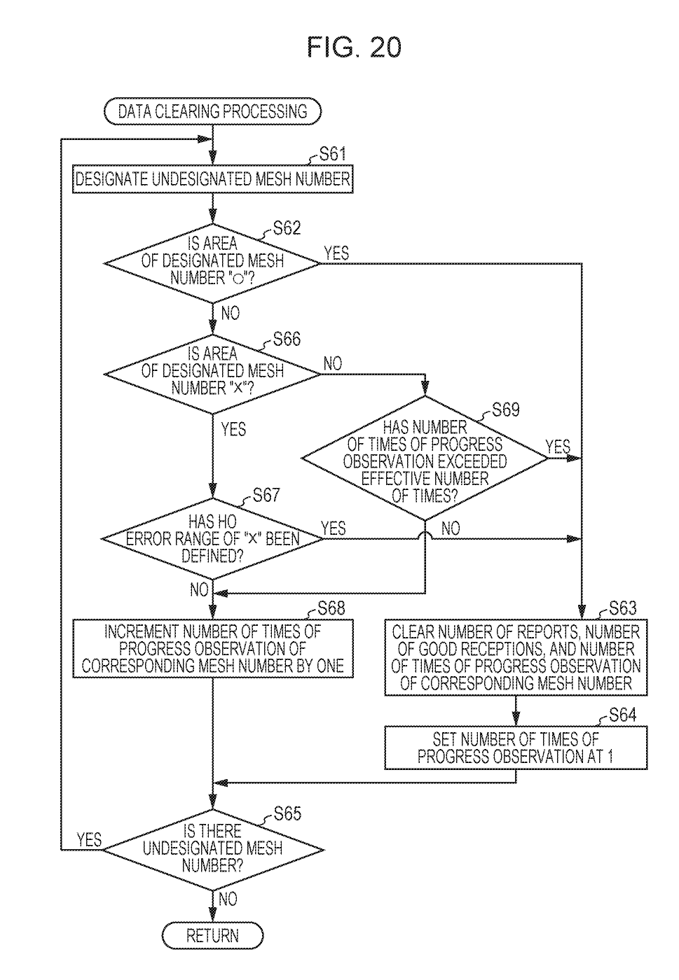

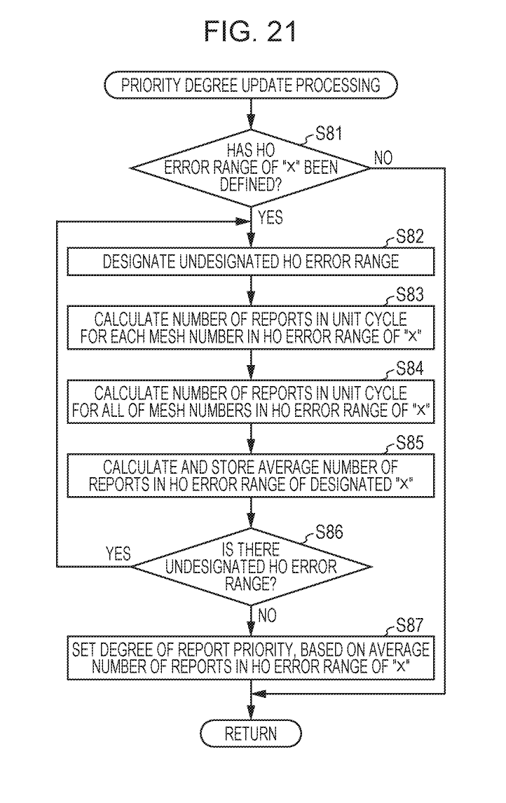

Furthermore, after executing the area defining processing, the second analysis unit 54 executes the data clearing processing illustrated in FIG. 20 (Step S41). Furthermore, after executing the data clearing processing, the second analysis unit 54 executes the priority degree update processing illustrated in FIG. 21 (Step S42), and terminates the processing operation illustrated in FIG. 18.

In the second analysis processing illustrated in FIG. 18, when the number of reports 63B for each mesh number 63A in the monitoring table 63 is the predetermined number of reports or more, the quality ratio for each mesh number 63A is calculated based on the number of reports 63B and the number of good receptions 63C. In the second analysis processing, when the quality ratio for each mesh number 63A is less than the predetermined quality ratio, the area of the corresponding mesh number 63A is determined as a HO error area. As a result, the monitoring device 4 may specify a HO error area among areas of a plurality of mesh numbers.

In the second analysis processing, when the quality ratio for each mesh number is not less than the predetermined quality ratio, the area of the corresponding mesh number 63A is determined as a HO area. As a result, the monitoring device 4 may specify a HO area among areas of a plurality of mesh numbers.

In the second analysis processing, when the number of reports for each mesh number is not the predetermined number of reports or more, the area of the corresponding mesh number is determined as an undefined area. As a result, the monitoring device 4 may specify an undefined area among areas of a plurality of mesh numbers.

FIG. 19 is an operational flowchart illustrating an example of a processing operation of the monitoring device 4 related to the area defining processing. The area defining processing illustrated in FIG. 19 is processing of registering, when the area of the mesh number of “-” in the area table 64 is surrounded by “χ″s under a predetermined condition, the mesh number of “-” as “χ”. In FIG. 19, the defining unit 54C in the monitoring device 4 refers to the mesh numbers of “χ” and “-” in the area table 64 (Step S51) and designates an undesignated mesh number of “-” (Step S52).

The defining unit 54C determines whether or not the area of the designated mesh number of “-” is surrounded by “χ″s (Step S53). Note that the area surrounded by “χ″s is an area of “-” adjacent to areas of a plurality of “χ″s, that is, for example, the area of the mesh number “B2” illustrated in FIG. 14C. When the area of the designated mesh number of “-” is surrounded by “χ″s (YES in Step S53), the defining unit 54C estimates the area of the designated mesh number of “-” as a HO error area “χ” and thus registers the area of the designated mesh number of “-” as a HO error area “χ” (Step S54). Furthermore, the defining unit 54C determines whether or not there is an undesignated mesh number of “-” (Step S55).

When there is an undesignated mesh number of “-” (YES in Step S55), the defining unit 54C moves the process to Step S52 in order to designate the undesignated mesh number of “-”. When there is not an undesignated mesh number of “-” (NO in Step S55), the defining unit 54C designates the undesignated mesh number of “χ” (Step S56) and determines whether or not there is an area of “-”, which is adjacent to the area of the designated mesh number of “χ” (Step S57).

When there is an area of “-”, which is adjacent to the area of the designated mesh number of “χ” (YES in Step S57), the defining unit 54C moves the process to Step S56 in order to designate an undesignated mesh number of “χ”.

When there is not an area of “-”, which is adjacent to the area of the designated mesh number of “χ” (NO in Step S57), the defining unit 54C defines a HO error range of the mesh number of “χ” (Step S58). Furthermore, the defining unit 54C determines whether or not there is an area of an undesignated mesh number of “χ” (Step S59). When there is an area of an undesignated mesh number of “χ” (YES in Step S59), the defining unit 54C moves the process to Step S56 in order to designate the undesignated mesh number of “χ”. When there is not an area of an undesignated mesh number of “χ” (NO in Step S59), the defining unit 54C terminates the processing operation illustrated in FIG. 19.

In the area defining processing illustrated in FIG. 19, when there is an area, among areas of mesh numbers of “-” in the area table 64, which is adjacent to a plurality of areas of “χ”, the area of the mesh number of “-” is estimated as a HO error area “χ” and is thus registered as a HO error area “χ”. As a result, the defining unit 54C may estimate and register an undefined area which is adjacent to a plurality of HO error areas as a HO error area, and therefore, the HO error area may be specified in advance.

FIG. 20 is an operational flowchart illustrating an example of a processing operation of the monitoring device 4 related to the data clearing processing. The data clearing processing illustrated in FIG. 20 is processing of clearing, when the number of times of progress observation 63D exceeds an effective number of times for each mesh number 63A in the monitoring table 63, the number of reports 63B and the number of good receptions 63C of the corresponding mesh number 63A. In FIG. 20, after the area defining processing illustrated in FIG. 19 is executed, the clearing unit 54D in the monitoring device 4 designates an undesignated mesh number in the area table 64 (Step S61), and determines whether or not the area of the corresponding mesh number, which has been designated, is a HO area “ο” (Step S62).

When the area of the designated mesh number is a HO area “ο” (YES in Step S62), the clearing unit 54D clears the number of reports 63B, the number of good receptions 63C, and the number of times of progress observation 63D, which correspond to the designated mesh number 63A in the monitoring table 63 (Step S63). The clearing unit 54D sets the number of times of progress observation 63D corresponding to the mesh number 63A at “1” (Step S64), and determines whether or not there is an undesignated mesh number (Step S65). When there is an undesignated mesh number (YES in Step S65), the clearing unit 54D moves the process to Step S61 in order to designate an undesignated mesh number. Furthermore, when there is not an undesignated mesh number (NO in Step S65), the clearing unit 54D terminates the processing operation illustrated in FIG. 20.

When the area of the designated mesh number is not a HO area “ο” (NO in Step S62), the clearing unit 54D determines whether or not the area of the designated mesh number is a HO error area “χ” (Step S66). When the area of the designated mesh number is a HO error area “χ” (YES in Step S66), the clearing unit 54D determines whether or not a HO error range of “χ” has been defined (Step S67).

When a HO error range of “χ” has not been defined (NO in Step S67), the clearing unit 54D increments the number of times of progress observation 63D of the corresponding mesh number 63A in the monitoring table 63 by one (Step S68). Then, the clearing unit 54D moves the process to Step S65 in order to determine whether or not there is an undesignated mesh number.

When the area of the designated mesh number is not a HO error area “χ” (NO in Step S66), the clearing unit 54D determines whether or not the number of times of progress observation 63D of the corresponding mesh number 63A has exceeded the effective number of times (Step S69). When the number of times of progress observation 63D of the corresponding mesh number 63A has exceeded the effective number of times (YES in Step S69), the clearing unit 54D moves the process to Step S63 in order to clear the number of reports 63B, the number of good receptions 63C, and the number of times of progress observation 63D of the corresponding mesh number 63A.

When the number of times of progress observation 63D of the corresponding mesh number 63A has not exceeded the effective number of times (NO in Step S69), the clearing unit 54D moves the process to Step S68 in order to increment the number of times of progress observation 63D of the corresponding mesh number 63A in the monitoring table 63 by one. When a HO error range of “χ” has been defined (YES in Step S67), the clearing unit 54D moves the process to Step S63 in order to clear the number of reports 63B, the number of good receptions 63C, and the number of times of progress observation 63D, which correspond to the designated mesh number 63A in the monitoring table 63.

In the data clearing processing illustrated in FIG. 20, when the area of a designated mesh number is a HO area “ο”, the number of reports 63B, the number of good receptions 63C, and the number of times of progress observation 63D, which correspond to the corresponding mesh number 63A in the monitoring table 63, are cleared.

In the data clearing processing, when the area of a designated mesh number is a HO error area “χ” and a HO error range has not been defined, the number of times of progress observation 63D corresponding to the corresponding mesh number 63A in the monitoring table 63 is incremented by one.

In the data clearing processing, when the area of a designated mesh number is an undefined area and the number of times of progress observation 63D corresponding to the corresponding mesh number 63A in the monitoring table 63 has exceeded the effective number of times, the number of reports 63B, the number of good receptions 63C, and the number of times of progress observation 63D of the corresponding mesh number 63A are cleared. In this way, since a tally result is too old to be sample data when the number of times of progress observation 63D has exceeded the effective number of times, the monitoring device 4 deletes the tally result when the number of times of progress observation 63D has exceeded the effective number of times.

In the data clearing processing, when the area of a designated mesh number is an undefined area and the number of times of progress observation 63D of the corresponding mesh number 63A in the monitoring table 63 has not exceeded the effective number of times, the number of times of progress observation 63D of the corresponding mesh number 63A in the monitoring table 63 is incremented by one.

FIG. 21 is an operational flowchart illustrating an example of a processing operation of the monitoring device 4 related to the priority degree update processing. In the priority degree update processing, when a plurality of HO error ranges are defined in the area defining processing, for each of the HO error ranges, average numbers each indicating an average number of reports of all the mesh numbers in one of the plurality of HO error ranges are compared to one another, and, based on a result of the comparison, the degree of report priority is set for each of the mesh numbers in the each HO error range. In FIG. 21, after the area defining processing is executed, the update unit 54E in the monitoring device 4 determines whether or not a HO error range of “χ” has been defined (Step S81). Note that the HO error range is made up of the area of “χ” of a single mesh number or the areas of “χ” of a plurality of mesh numbers.

When a HO error range of “χ” has been defined (YES in Step S81), the update unit 54E designates an undesignated HO error range of “χ” (Step S82) and calculates the number of reports in a unit cycle for each mesh number in the designated HO error range of “χ” (Step S83). Note that the update unit 54E calculates the number of reports in a unit cycle by dividing the number of reports 63B in the monitoring table 63 by the number of times of progress observation 63D.

The update unit 54E adds up the number of reports in a unit cycle for each mesh number in the designated HO error range of “χ” to calculate the total number of reports in a unit cycle for all the mesh numbers in the HO error range of “χ” (Step S84). The update unit 54E calculates an average number of reports by dividing the total number of reports, which has been calculated, by the total number of meshes in the HO error range of “χ”, and stores the average number of reports in mesh units of the designated HO error range (Step S85).

After storing the average number of reports in mesh units of the designated HO error range of “χ”, the update unit 54E determines whether or not there is an undesignated HO error range of “χ” (Step S86). When there is an undesignated HO error range of “χ” (YES in Step S86), the update unit 54E moves the process to Step S82 in order to designate the undesignated HO error range of “χ”.

When there is not an undesignated HO error range of “χ” (NO in Step S86), the update unit 54E sets, based on the average number of reports in mesh units for each of currently stored HO error ranges, the degree of report priority for each HO error range of “χ” (Step S87). Then, the update unit 54E terminates the processing operation illustrated in FIG. 21. Note that the update unit 54E sets the degree of report priority of each HO error range in accordance with the magnitude of the average number of reports.

In the priority degree update processing, after a plurality of HO error ranges is defined, for each HO error range, average numbers each indicating an average number of reports of all the mesh numbers in the corresponding HO error range are compared to one another, and based on a result of the comparison, a higher degree of report priority is set for a HO error range whose average number of reports is larger. As a result, the monitoring device 4 may report the HO error ranges to the monitoring terminal 5 in descending order of the degree of report priority.

The monitoring device 4 according to the embodiment specifies a HO error area, based on quality information for each mesh number 63A. Furthermore, when, in an undefined area adjacent to the specified HO error area, peripheries of the undefined area are adjacent to a plurality of HO error areas, the monitoring device 4 estimates the undefined area as a HO error area. As a result, the monitoring device 4 may estimate an area in which a HO error is likely to occur due to change in external environment even when a HO error has not actually occurred. That is, a HO error range, in which there is a potential high probability that HO will fail, may be detected in advance by detecting in advance an area in which there is not a HO destination and an area whose communication quality level is low.

The monitoring device 4 defines a HO error range made up of HO error areas that are adjacent to one another, among areas of a plurality of mesh numbers, and reports all the mesh numbers in the defined HO error range to the monitoring terminal 5. As a result, based on the mesh numbers in the HO error range, a maintenance party of the monitoring terminal 5 may recognize the HO error range, and thus, may increase the power of cells in the HO error range, change a tilt angle, and additionally construct base stations 3 and femto cells, so that HO errors are reduced.

When there is a plurality of defined HO error ranges, the monitoring device 4 acquires, for each HO error range, the numbers of reports 63B of all the mesh numbers in the corresponding HO error range from the monitoring table 63. Furthermore, the monitoring device 4 sets, based on the number of reports in mesh units for each HO error range, the degree of report priority for each HO error range. The monitoring device 4 reports, based on the degree of report priority, which has been set, all the mesh numbers in the HO error range. As a result, based on the degree of report priority, the maintenance party of the monitoring terminal 5 may recognize the HO error range in order to quickly recover a HO error.

Note that, in the above-described embodiment, a zone for each mesh number is illustrated in a quadrangular shape, but is not limited to a polygonal shape, such as a quadrangular shape, and may be a circular shape or the like. Furthermore, in the above-described embodiment, a HO error area has been described as an area having a communication environment in which HO is unavailable, but a HO error area may be an area having a communication environment in which, although HO is available, only predetermined poor communication quality may be provided.

Also, each component element of each unit illustrated in the drawings may not be physically configured as illustrated in the drawings. That is, specific embodiments of disintegration and integration of each unit are not limited to those illustrated in the drawings, and all or some of the units may be disintegrated/integrated functionally or physically in an arbitrary unit in accordance with various loads, use conditions, and the like.

Furthermore, the whole or a part of each processing function performed by each device may be executed on a central processing unit (CPU) (or a microcomputer, such as a micro processing unit (MPU), a micro controller unit (MCU), and the like). Also, needless to say, the whole or a part of each processing function may be executed on a program that is analyzed and executed by a CPU (or the microcomputer, such as a MPU, a MCU, and the like) or a hardware of a wired logic.

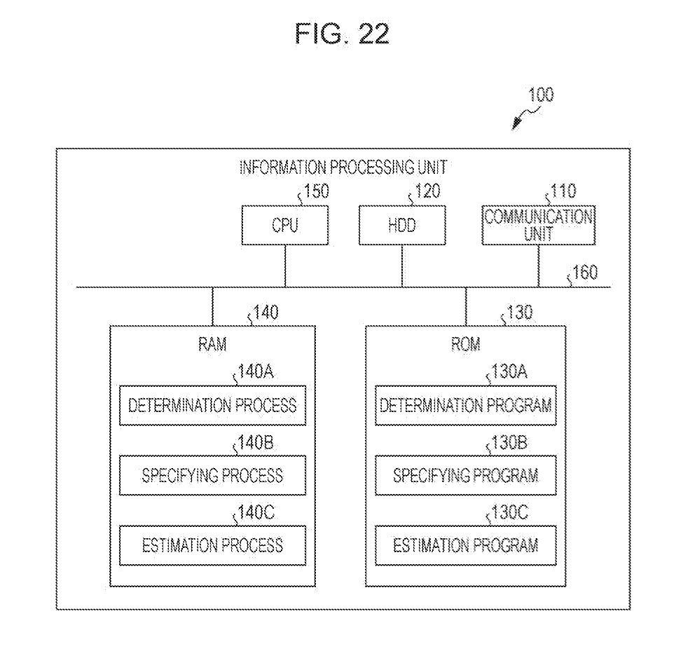

Various types of processing described in the above-described embodiment may be realized by causing a processor, such as a CPU, provided in an information processing device to execute a program prepared in advance. Thus, an example of the information processing device that executes a program having a function similar to the corresponding one of the above-described embodiment will be described below. FIG. 22 is an explanatory diagram illustrating an example of the information processing device that executes a monitoring program.

An information processing device 100 configured to execute a monitoring program, which is illustrated in FIG. 22, includes a communication unit 110, a hard disc drive (HDD) 120, a ROM 130, a RAM 140, and a CPU 150. The communication unit 110, the HDD 120, the ROM 130, the RAM 140, and the CPU 150 are coupled to one another via a bus 160.

A monitoring program that exhibits a similar function to that described in the above-described embodiment is stored in the ROM 130 in advance. As the monitoring programs, a determination program 130A, a specifying program 130B, and an estimation program 130C are stored in the ROM 130. Note that, the monitoring programs may be recorded in a computer-readable recording medium by a drive (not illustrated), not in the ROM 130. Also, as the recording medium, for example, a portable recording medium, such as a CD-ROM, a DVD disk, and a USB memory, a semiconductor memory, such as a flash memory, or the like may be used.

The CPU 150 reads out the determination program 130A from the ROM 130 and functions as a determination process 140A on the RAM 140. Furthermore, the CPU 150 reads out the specifying program 130B from the ROM 130 and functions as a specifying process 140B on the RAM 140. The CPU 150 reads out the estimation program 130C from the ROM 130 and functions as an estimation process 140C on the RAM 140.

The CPU 150 refers to communication quality of communication with each base station for each position information collected from a mobile station, and determines, based on the communication quality for each zone, which corresponds to the position information, whether or not HO communication among a plurality of base stations is unavailable. When HO communication among a plurality of base stations is unavailable, the CPU 150 specifies the zone as an unavailable area. When HO communication in a zone adjacent to the zone specified as an unavailable area is undefined and peripheries of the undefined zone are adjacent to a plurality of zones of unavailable areas, the CPU 150 estimates the undefined zone as an unavailable area. As a result, an area in which a HO failure is likely to occur may be estimated.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A monitoring device comprising:
a processor configured to:
collect, from mobile stations, first information indicating communication qualities of communications between the mobile stations and base stations, in association with position information indicating a position of each of the mobile stations,
determine, based on the first information for each of zones corresponding to the position information, whether a handover communication of a first mobile station to a first zone is unavailable,
upon determining that the handover communication of the first mobile station to the first zone is unavailable, specify the first zone as an unavailable area, and
when availability of the handover communication to a second zone, which is adjacent to the first zone of the unavailable area, is not defined yet and the second zone is adjacent to a plurality of the first zones determined as the unavailable area, estimate the second zone as the unavailable area; and
a memory coupled to the processor, the memory being configured to store the first information.

2. The monitoring device of claim 1, wherein
the processor is further configured to:
define an unavailable range that is made up of the first zones that are adjacent to one another, among a plurality of zones; and
report identification numbers identifying all the first zones in the defined unavailable range.

3. The monitoring device of claim 2, wherein
the processor is further configured to:
when there are a plurality of the unavailable ranges, acquire, for each of the unavailable ranges, a number of samples of communication qualities of all the first zones in the each unavailable range, and
set, based on the number of samples for each of the unavailable ranges, a degree of priority for each of the unavailable ranges; and
the processor reports, based on the set degree of priority, identification numbers of all the first zones in each of the unavailable ranges.

4. A method for causing an information processing device to execute a process, the process comprising:
collecting, from mobile stations, first information indicating communication qualities of communications between the mobile stations and base stations, in association with position information indicating a position of each of the mobile stations,
determining, based on the first information for each of zones corresponding to the position information, whether a handover communication of a first mobile station to a first zone is unavailable,
upon determining that the handover communication of the first mobile station to the first zone is unavailable, specifying the first zone as an unavailable area, and
when the availability of the handover communication to a second zone, which is adjacent to the first zone of the unavailable area, is not defined yet and the second zone is adjacent to a plurality of the first zones determined as the unavailable area, estimating the second zone as the unavailable area.

5. A non-transitory, computer-readable recording medium having stored therein a program for causing a computer to execute a process, the process comprising:
collecting, from mobile stations, first information indicating communication qualities of communications between the mobile stations and base stations, in association with position information indicating a position of each of the mobile stations;
determining, based on the first information for each of zones corresponding to the position information, whether a handover communication of a first mobile station to a first zone is unavailable;
upon determining that the handover communication of the first mobile station to the first zone is unavailable, specifying the first zone as an unavailable area; and
when the availability of the handover communication to a second zone, which is adjacent to the first zone of the unavailable area, is not defined yet and the second zone is adjacent to a plurality of the first zones determined as the unavailable area, estimating the second zone as the unavailable area.
